(19) United States
(12) Patent Application Publication
(10) Pub. No.: US 2024/0242253 A1
(43) Pub. Date: Jul. 18, 2024

(54) Platform for Facilitating Metal Products Transactions

(71) Applicant: Bryzos, LLC, St. Louis, MO (US)

(72) Inventor: Justin S. Hickey, St. Louis, MO (US)

(21) Appl. No.: 18/415,467

(22) Filed: Jan. 17, 2024

Related U.S. Application Data
(60) Provisional application No. 63/439,690, filed on Jan. 18, 2023.

(51) Int. Cl. G06Q 30/0283; G06Q 30/0601

(52) U.S. Cl. CPC G06Q 30/0283; G06Q 30/0627; G06Q 30/0633

(57) ABSTRACT

In one embodiment, a method includes receiving, at a computing device and from a client device, a search string for a metal product, the search string having been input by a user of the client device. The method further includes determining, by the computing device, a set of one or more search results based on the received search string, each search result (1) based on the search string, and (2) corresponding to a particular metal product; transmitting, from the computing device and to the client device, the set of one or more search results for display on the client device; determining, by the computing device, a price, that is not determined by any particular seller of the metal product, for at least one of the particular metal products; and transmitting, from the computing device and to the client device, the price for display on the client device.

### PRIORITY CLAIM

This application claims the benefit, under 35 U.S.C. § 119, of U.S. Provisional Patent Application No. 63/439,690 filed Jan. 18, 2023, which is incorporated by reference herein.

### TECHNICAL FIELD

This application generally relates to transactions for metal products.

### BACKGROUND

The metals industry relates to manufactured metal products of various shapes, sizes, and materials. For example, metal products include pipes, sheets, beams, bars, etc. of metal ores or alloys such as steel of various forms (e.g., carbon steel, stainless steel, etc.), aluminum, iron, copper, brass, and other material types. For metal products, some manufacturing occurs on raw materials (e.g., ores) to create a metal product. For example, metals may be combined with other materials to form an alloy, such as stainless steel, and alloys or other metal materials may be sized and shaped into a particular product, such as a pipe of a certain diameter and length, or a beam of a certain size. These metal products are not merely typical consumer products made of metal, such as a piece of jewelry, but rather are typically industrial products. Manufacturing processes for metals products can have a role in determining the type of metal product, and different manufacturing processes may result in different metal products. As one example, a cold-rolled steel sheet of a given size is considered a different product than a hot-rolled steel sheet of the same size.

### BRIEF DESCRIPTION OF THE DRAWINGS

FIG. 1 illustrates an example architecture and flow diagram for facilitating transactions involving metal products.

FIG. 2 illustrates an example of a user interface that may be presented on a display of a client device.

FIG. 3 illustrates an example UI illustrating an example search string and corresponding search results.

FIG. 4 illustrates an example UI for creating a purchase order for one or more metal products

FIG. 5 illustrates an example UI displayed on a seller device.

FIG. 6 illustrates an example computing system.

FIG. 7 illustrates an example UI displayed on a seller device to preview a purchase order.

FIG. 8 illustrates an example UI displayed on a seller device to accept a purchase order.

### DESCRIPTION OF EXAMPLE EMBODIMENTS

Transactions involving metal products currently involve a buyer creating a purchase query that identifies the metal products the buyer wishes to purchase. The buyer must then send the purchase query to particular sellers from which the buyer may be willing to purchase the metal product(s). Sellers check their inventory and respond to the buyer's purchase query with a quoted price for the metal product(s), if the seller is willing to fulfill the transaction. Many of the purchase queries a buyer sends may be dead ends, because the seller does not have the product or cannot economically ship that product to the buyer's location within the timeframe request by the buyer, etc. However, a buyer does not know those details for a particular purchase query until the buyer sends the query to a particular seller and waits to receive a response from that seller. In addition, buyers do not know what prices a particular seller will quote until receiving the seller's response to the buyer's purchase query. This process can take a considerable amount of time, and although some or all of the steps may occur using a computer, at least some of the steps frequently occur using alternative communications such as telephones and fax machines, further increasing the time spent on obtaining a particular metal product.

In contrast to the conventional approach described above, the platform described herein enables a buyer to search for metal products on a user interface (UI) of the platform. The platform backend uses search logic to identify a specific product based on the search terms, which may vary widely among buyers. If the product is identified in the platform's product database, the platform then immediately identifies a purchase price for the product (e.g., a price per unit, such as price per linear foot). Importantly, the product database does not correspond to any particular seller's inventory, nor is the quoted price merely the price quoted by any particular seller. Instead, as explained more fully below, the platform automatically identifies metal products and provides a predetermined price, which may be updated in real time, so that buyers can immediately proceed with their purchase requests.

Using the platform described herein, buyers can create a purchase order without having to actually contact particular sellers to determine stock, price, etc., in contrast to conventional digital marketplaces (e.g., Amazon, eBay, etc.), in which placing an order involves selecting a particular product from a particular seller and proceeding with a purchase request directed to that particular seller. Sellers do not need to upload product inventory to the platform described herein, nor do sellers need to manage any product inventory on the platform, as any particular seller's inventory is not part of the platform, in contrast to typical digital purchasing approaches, in which sellers directly manage their inventory and a digital marketplace (e.g., Amazon, eBay, etc.) is simply a digitized storefront for the sellers' products. In contrast, the platform described herein is not a digitized storefront for any particular seller. Instead, when a buyer submits a purchase order for a product at the price identified by the platform UI, the purchase order is then submitted to participating sellers, who, as explained below, can electronically agree to fulfill the purchase order or can simply ignore the order, as from the buyer's perspective, the purchase order is not a direct request directed to any particular seller, unlike the conventional approaches described above. As described below, the platform UI may intentionally be very simple; for example, three total screens may be used to search for products and to create and fulfill a purchase order.

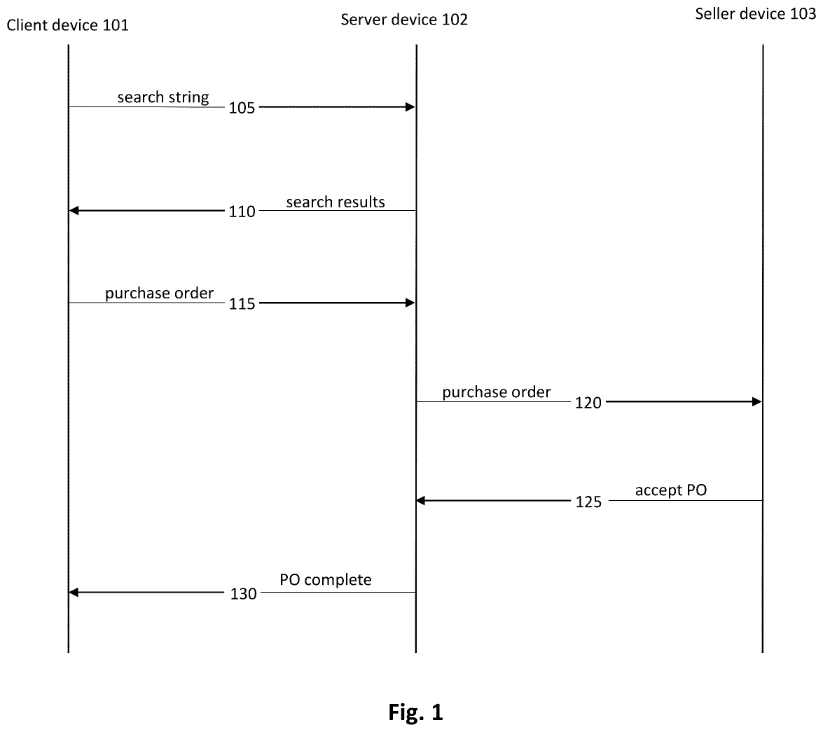

FIG. 1 illustrates an example architecture and flow diagram for facilitating transactions involving metal products. The example architecture of FIG. 1 includes a client device 101, such as a personal computer, a smartphone, or other client device that executes an application or accesses a website associated with the platform backend described herein. The example architecture of FIG. 1 also includes a server device 102, which may be one or more computing devices for performing certain backend functions of the platform described herein. The example architecture of FIG. 1 also includes a seller device 103, which may be a personal computer, a smartphone, etc., that executes an application or accesses a website associated with the backend described herein. While the example of FIG. 1 illustrates a single client device 101 and a single seller device 103, in practice the architecture of FIG. 1 may include many client devices and many seller devices, as described more fully below.

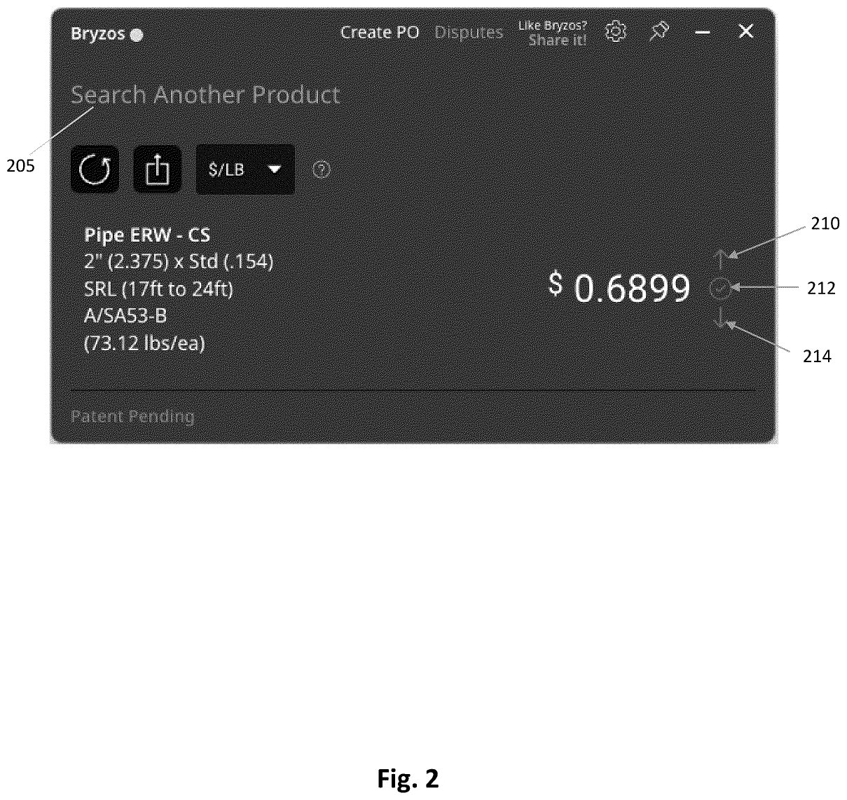

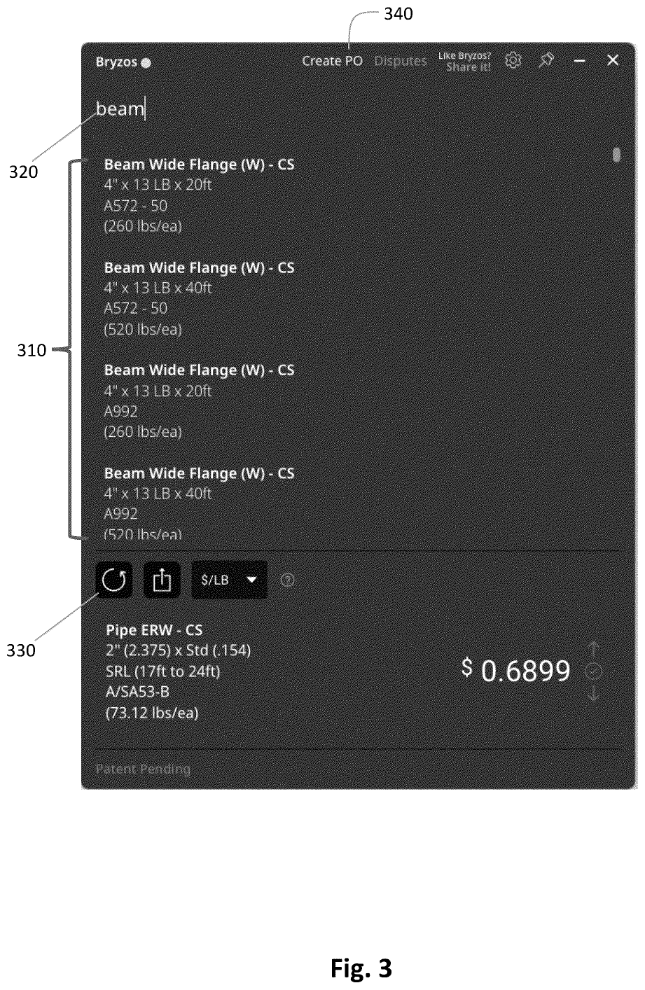

An application or website accessed by client device 101 presents, on a display of a client device, a user interface associated with the platform described herein. FIG. 2 illustrates an example of a user interface that may be presented on a display of a client device. The user interface illustrated in FIG. 2 may be presented by an application associated with the backend described herein or may be presented by a website associated with the backend described herein. While examples of this disclosure at times describe presentation of the UI elements of FIGS. 2 and 3 in connection with a buyer, this disclosure contemplates that any user registered with the platform may use a client device to access these UI elements and corresponding functionality.

As illustrated in the example of FIG. 2, a user interface may include a search element 205. A user of a client device, for example a buyer interested in purchasing a particular metal product, may access the user interface. In particular embodiments, a user may need to create an account with the platform prior to accessing the platform (i.e., prior to accessing the example user interface of FIG. 2). For example, a user may need to enter credentials such as a username or email address, and after account approval, a user can then access the platform, for example by using a passcode provided by the platform or by using a password created by the user to access their user account on the platform.

A user can access a search field, such as example search element 205, and input text (e.g., one or more alphanumeric strings) into the search bar to search for a particular metal product. FIG. 3 illustrates an example in which a user has entered the string “beam” into search element 205. Upon entry of input into a search element, the client device may transmit the search string, in real time, to the backend. For instance, in the example of FIG. 1, client 101 transmits a search string 105 to a backend server device 102.

Server device 102 receives the search string for the metal product and determines a set of one or more search results based on the search string. Each search result corresponds to a particular metal product. For example, server device 102 may host a database of metal products identified by the platform, or may access such database from another backend device associated with the platform. Server device 102 executes search logic in real-time, i.e., as the user is interacting with the user interface on client device 101, to determine which search results correspond to the user's search string.

In practice, users searching for metal products in the metals industry may use a wide variety of search terms to identify products. In addition, two different users may use vastly different vernacular, including different search terms, to identify the same metal product. For example, a metal product identified as “beam wide flange (W)” may be searched for using terms such as “beam” “BWF” or just “w” followed by dimension, e.g., “w4×13,” even though each of these search terms is attempting to find the same metal product. Thus, server device 102 disambiguates the search term input by the user and determines which results, if any, in the product database correspond to metal products the user may be searching for.

In particular embodiments, a product database may include a full identifier of the product, such as a plain-language description of the product. This description may be a full product name, such as “beam wide flange (W),” as stored in the product database. In addition, a product database may include, for each metal product, a number of additional identifiers that search logic uses to associate user search input with a particular product. Such identifiers may include parameters associated with a particular metal product. For example, a product may be identified by “pipe ERW-CS”. A search for that product name, or for partial strings in that name (e.g., “pipe ER”) would return the “pipe ERW-CS” product as a search result. Search strings that match other identifiers may also return the “pipe ERW-CS” product as a search result. For example, a search for the product shape (here “pipe,” with other shapes including plates, sheets, beams, etc.) would return corresponding products with that shape as a search result. As another example, a search for a product type (here “ERW” or “electrical resistance welded”) would return corresponding products of that type in response to the search result. As another example, a type of material (here “CS” or “carbon steel,” with other examples including aluminum, stainless steel, and other kinds of metals and alloys) would return corresponding products of that material as a search result. As another example, a search for a dimensional size of the product, such as 6″ (6.625)×XH (0.432) (which means 6″ nominal size, 6.625″ outer diameter, a 0.432″ wall thickness, and an industrial wall-thickness identifier of “XH”) would return corresponding products of those dimensions as a search result. As another example, a search for a length of a product material, such as “SRL (17 ft to 24 ft)”, which means a single-random length pipe of between 17 feet and 24 feet) would return corresponding products of those lengths as a search result. As another example, a search for a specification or grade of a product material, such as “A/SA53-B” (which defines the chemical and physical properties of the specific material), would return corresponding products of that specification or grade as a search result. Moreover, search terms are not limited to the product identifiers above, and any suitable identifier may be associated with a particular product in a product database so that the search logic of server device 102 determines search results from an input string.

As illustrated in the examples above, many different approaches may be used to search for a particular metal product. In addition, users searching for particular metal product may blend identifiers into a single string, and/or may use shorthand to identify some or all identifiers related to a product. For example, searches for (1) “pipe 6″ xh”, (2) “6″ 0.432”, and (3) “6″ erw” may all be for the same product, i.e., Pipe ERW-CS 6″ (6.625)×XH (0.432) SRL (17 ft to 24 ft) A/SA53-B (572 lbs/ea). None of those three examples search strings, however, match any particular identifier of that product. Therefore, server device 102 may execute search logic that parses the alphanumeric identifiers in the product database and immediately matches (i.e., in real time) portions of the input search string to portions of the identifiers in the database. For instance, in the example above, both “erw” and “0.432” appear in a product identifier, and therefore a search string of “erw 0.432” would return that product. As a result, in the example architecture of FIG. 1, each of the three example search strings identified above results in server 102 identifying the product described above as a search result for the search string. In particular embodiments, all database content that is maintained by, or associated with, server device 102 loads at the time a user signs in, which allows for instant display of product and price results, rather than loading at the time each search is being conducted.

In particular embodiment, search logic may include semantic and syntactic analysis, such as the degree of character or phrase matching and/or the possibility of transposed characters (e.g., “ewr” vs. “erw”). In particular embodiments, search results may be ranked based on the degree, or likelihood, of match between an input search string and a product.

In particular embodiments, search logic may be refined with machine learning (ML) based on an analysis of user search inputs and corresponding selected search results. For example, suppose a set of search results is delivered to a user in response to a search input, and a user selects the third search result. The user's client device reports this selection to the server device, which stores and records users' search strings and the corresponding presented and selected search results. This recorded data may then be analyzed over time to update search rules and/or the order of search results. For example, if users consistently picked the third search result in the preceding example, then this search result may be moved to the top of the displayed search results for the same or similar search terms. This adjustment may be performed, for example, by maintaining and updating a weight for search results that is based at least in part on historical user data regarding search terms and subsequent interactions (e.g., selected search results).

The products identified by, and the associated information maintained by, the platform (e.g., by a database stored by or accessible to server device 102) do not correspond to any particular seller, in that the products identified are not indicative of any particular seller's inventory, nor do the product names and identifiers necessarily correspond to any particular seller's product listing, even for the same product. For example, the “beam wide flange” search results shown in FIG. 3 do not necessarily correspond to the product name maintained by any particular seller. Instead, the product identifiers and associated information maintained by the platform represent an easily understood description of each product so that buyers and sellers can immediately identify to which product is being referred.

Step 110 of the example method of FIG. 1 includes transmitting, from the computing device and to the client device, the set of one or more search results for display on the client device. The client device presents the search results on the user interface. FIG. 3 illustrates an example user interface showing search results 310 in response to user input “beam” into search bar 320. As illustrated in the example of FIG. 3, in addition to an identification of a metal product, additional product information such as dimensions, length, grade, and weight may be presented in a search result for a particular metal product, in particular embodiments.

In particular embodiments, a user may create a purchase order for a particular metal product by interacting with (e.g., selecting) the corresponding search result for that product. A user may also clear the search and search results, for example by interacting with UI element 330 illustrated in the example of FIG. 3. Although not shown in the example of FIG. 3, in particular embodiments a price for a metal product may be displayed along with an identification of the product in a search result.

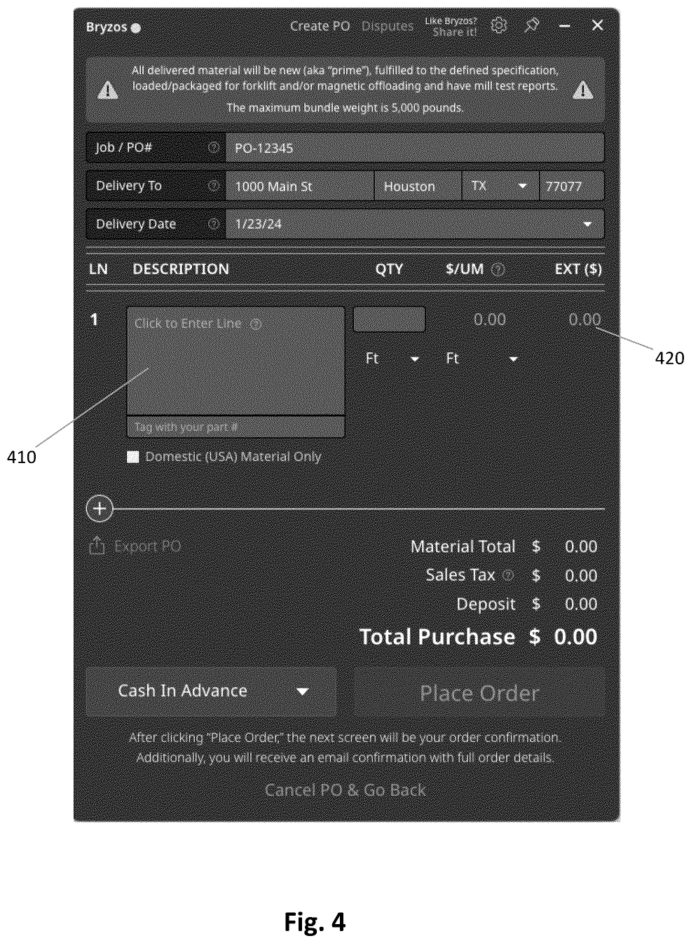

A user can create a purchase order by, for example, interacting with a particular search result, or by interacting with a dedicated UI element. For instance, in the example of FIG. 3, a user may interact with example UI element 340 to create a purchase order for one or more metal products. FIG. 4 illustrates an example UI for creating a purchase order for one or more metal products. The example purchase order of FIG. 4 includes an input area for identifying a delivery address for the metal product, and a user may also identify a job or purchase number for their own internal records. In the example of FIG. 4, a user can specify purchase terms for the order (e.g. cash in advance, domestic materials only, etc.).

The example purchase order of FIG. 4 includes a search area 410, in which a user may enter alphanumeric input in order to specify a particular metal product. In particular embodiments, input into search area 410 is transmitted to server device 102, which uses search logic as described above to determine search results, and server device 102 then transmits those search results to client device 101. A user may select among the search results on client device 102, or if the search corresponds to only one particular product, then that product may be entered into the purchase order automatically. A user may also enter a quantity for a product, and may specify the units (e.g., length, weight, etc.) for a product.

The example purchase order of FIG. 4 includes a price 420 that is displayed in connection with a particular metal product identified in the backend database. In particular embodiments, the price for a particular metal product is not determined by (or correspond to) any particular seller of that metal product, unlike in conventional online and offline marketplaces (as described above, the platform described herein is not a storefront for any particular seller, nor is it a digital aggregation of multiple online sellers). Instead, the price may be determined automatically by the backend platform.

For example, products in the database may be grouped into different sets organized according to an initial price of each metal product. Every product may be in one set, and the initial price for a particular metal product may be based on a current price of a particular supplier, on a current average price from a variety of suppliers, on a historical price, or any other suitable price for that product. The initial price may be converted to a per-unit price, e.g., per foot, per pound, per item, etc. Metal products may then be sorted by price and grouped into sets based on the initial price. Each set may have an upper and lower price threshold. For example, metal products with an initial unit price (e.g., price per unit length) of $30-$34 may be one set, products with an initial unit price of $35-$39 may be another set, etc., although this disclosure contemplates that other increments (e.g., $10 increments) may be used, and that the increment for each set may not necessarily be a fixed increment (e.g., the increments may vary as a certain percentage of the upper bound, etc.). Then, the prices in each set are averaged to create an overall set price for each metal product in that set. In other words, each metal product in the set is given the same overall set price, which is determined by averaging the prices for all metal products in that set. Then, when providing a price in connection with a particular metal product, the platform provides the overall set price for that product, which is not any particular seller's current price, nor is it even an aggregation of seller's prices for that product. In particular embodiments, products to include in a set may depend on the product's properties. For example, a set of steel products may be different than a set of aluminum products of the same price range. In particular embodiments, sets are formed exclusively based on unit price, so that very different products may be in the same set.

One result of the sets described above is that prices can be immediately presented to a buyer without having to obtain seller quotes and without requiring sellers to actively maintain their pricing information on the platform. Another result of the sets described above is that such sets reduce the negative impact of price variations and fluctuations for any particular product. For example, three different sellers may price the same product differently, resulting in three different prices for the same product. However, because the platform is not quoting any particular seller's price, pricing for that product on the platform is consistent across quote requests from buyers. In addition, a particular product's price may vary over time, for example based on regional availability. For instance, a particular product's price may temporarily increase in a particular region if supply is relatively low in that region. The approach described herein, however, smooths such variations by providing a price that is aggregated and based on the prices of other products in the same set, so that the overall set price of such products rises and falls together.

In particular embodiments, sets may change over time, for example by updating the initial price of one or more products and then creating updated sets based on the updated product prices. In particular embodiments, prices in a set may be adjusted based on interactions associated with the platform, which may be analyzed by one or more AI models to update one or more prices or to flag one or more prices for review. For example, in particular embodiments, a user interface that includes a price may also include one or more interactive elements for receiving user feedback regarding the price. For instance, the example UI of FIG. 2 illustrates element 210 for indicating that a presented price is perceived by a user (whether a buyer, a seller, or another party with access to the platform) to be high, element 212 for indicating that the presented price is perceived by the user to be accurate, or element 214 for indicating that the presented price is perceived by the user to be too low. In particular embodiments, prices for a particular product may be adjusted based on user interactions, such as buyer-side interactions. For example, if buyers search for a particular product and do not submit a purchasing order when presented with a price for that product, then such interactions may be recorded by the platform, and if a threshold number of such interactions occurs in a particular time period (or if the percentage of such interactions relative to interactions that proceed with a purchase order for that product exceed some threshold percentage), then the price of the corresponding product may be decreased, or may be flagged for review. As another example, if a purchase order for a particular product is transmitted to seller devices and is not accepted, e.g., after a certain period of time, then such interactions may be recorded by the platform, and if a threshold number of such interactions occurs in a particular time period (or if the percentage of such interactions relative to interactions that result in a purchase order for that product being accepted exceed some threshold percentage), then the price of the corresponding product may be decreased, or may be flagged for review. Similar adjustments to increase prices for particular metal products may also occur.

In particular embodiments, a price of a particular metal product in a set may be changed, which may move the product to a different set or may change the prices in the set based on the corresponding weighted amount. In particular embodiments, a particular metal product may be moved from one set into another, changing that product's overall set price. In particular embodiments, a product may be removed from a set, so that the product can be priced independently of the set pricing described herein.

In particular embodiments, a presented price may vary from a set price for a particular purchase order based on one or more aspects of the order. For example, a total-price discount may be provided for a particular purchase order relative to the per-unit set price for that order based on order volume (e.g., a volume discount may be provided). In particular embodiments, a total price may vary based on delivery location. In these examples, a product's set price may be accessed and then modified based on the aspects of the order.

Once a purchase order is filled out by a buyer, a user may then submit the purchase order, which transmits the purchase order from the client device to the backend platform. This is illustrated as step 115 in the example of FIG. 1, in which client device 101 transmits a purchase order to server device 102. Server device 102 then selects one or more seller devices 103 to which to send the purchase order. In particular embodiments, selecting one or more seller devices 103 to which to send the purchase order includes sending the purchase order to every seller associated with the platform who is not the buyer in this transaction (i.e., a buyer who is also a seller on the platform would not be able to fulfill their own purchase order). Typically, there will be many seller devices 103, each associated with a seller who has created an account with the platform. In addition, as the product and price identification described above does not correspond to, or come from, any particular seller, there isn't a single seller device 103 to which the purchase order corresponds, and therefore the platform transmits the purchase order to multiple seller devices 103.

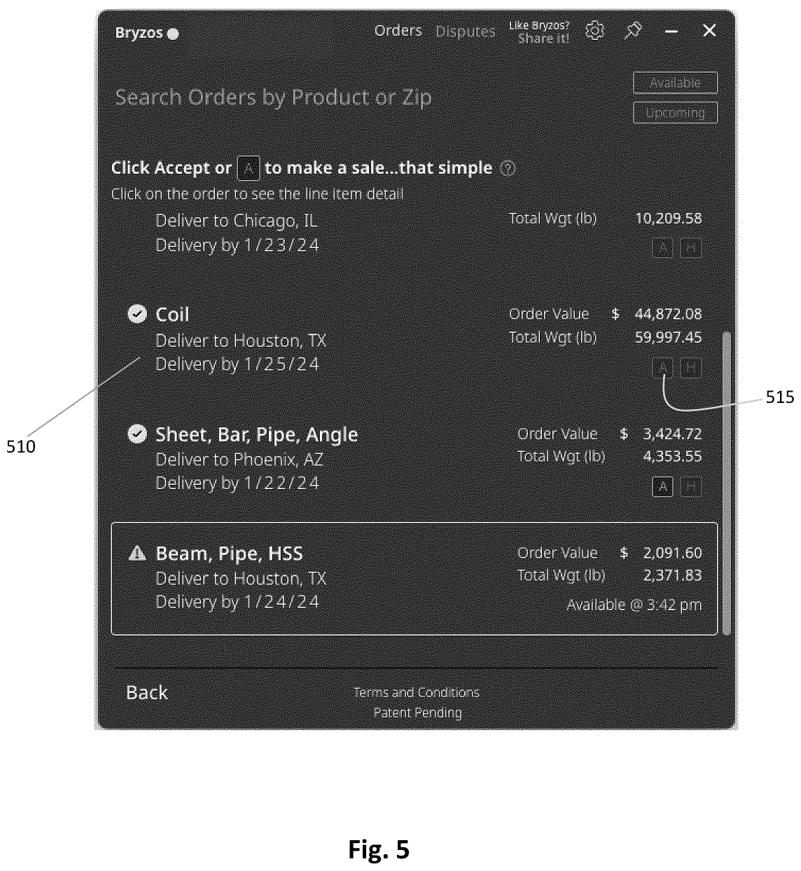

One or more purchase orders transmitted to a seller device 103 in step 120 may be displayed on the seller devices (or on an associated device). FIG. 5 illustrates an example UI displayed on a display of a seller device. As illustrated in the example of FIG. 5, the seller-device UI may include a search bar to search available orders, e.g., by product or by delivery location. A seller may review completed, available, and/or upcoming (as described more fully below) purchase orders on the UI, and may accept a purchase order that the seller wants to fulfill, for example by interacting with an element on the UI (e.g., in the example of FIG. 5, element 515 in example UI 510 accepts the corresponding purchase order).

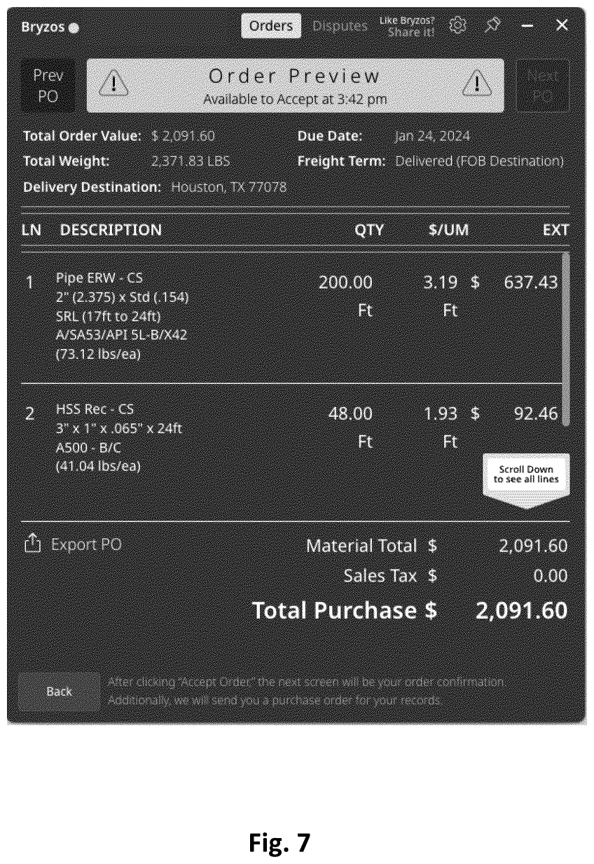

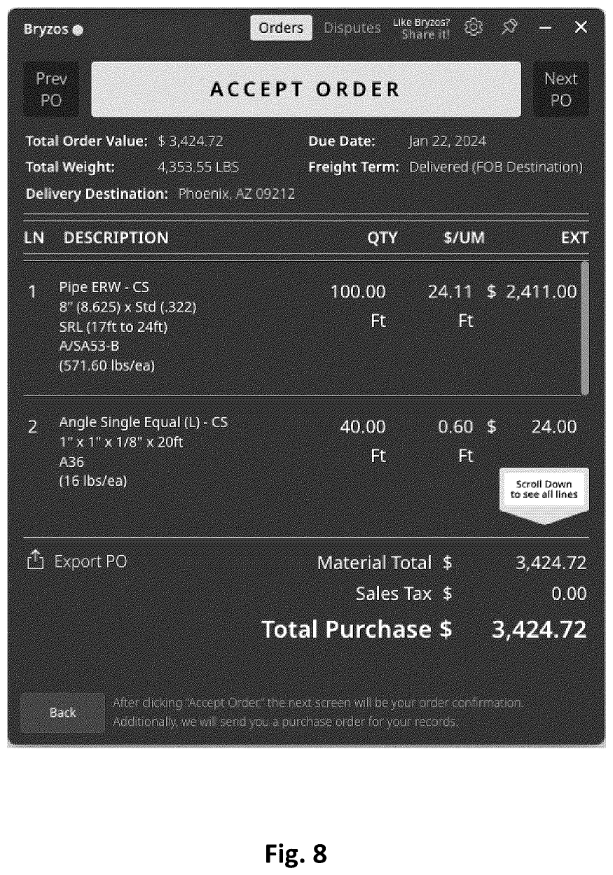

In particular embodiments, a purchase order transmitted from server device 102 to seller devices 103 may have a predetermined, mandatory waiting period during which any seller cannot accept the purchase order. For example, a server device 102 may transmit a purchase order to seller devices 103, and that purchase order may have a 1-hour waiting period during the purchase order cannot be accepted by any seller. FIG. 7 illustrates an example UI displayed on a seller device to preview a purchase order that has a mandatory waiting period. Once the mandatory waiting period passes, then any seller may accept the order. FIG. 8 illustrates an example UI displayed on a seller device to accept a purchase order. In particular embodiments, the first seller to accept any order may fulfill the order. In particular embodiments, if multiple sellers attempt to accept an order, then server device 102 may then award the order to the seller device 103 that clicked the accept button first, then send a notification to other sellers that they missed this particular order opportunity.

Once a seller device 103 accepts an available purchase order, seller device 103 transmits a request to accept the order to server device 102. Step 125 of the example of FIG. 1 illustrates an example transmitted request. Server device 102 then determines which seller will fulfill the order (or, in particular embodiments, may involve the buyer in such determinations). Server device 102 then transmits to client device 101 an identification of the seller and, when the purchase order is complete, an identification that the purchase order is finalized, for example as illustrated in step 130 of the example method of FIG. 1. In particular embodiments, purchasers and sellers may use the platform to communicate directly with each other, track the status of fulfilled orders (e.g., shipment information) and payment, and review available, in-progress, and completed orders made through the platform.

As described throughout—and because the platform does not correspond to any particular seller, nor offer products or prices from any particular seller—a seller does not need to actively manage a storefront on the platform, as sellers do on conventional physical and electronic marketplace platforms. For example, sellers do not need to list or maintain product information or pricing on the platform, nor do sellers need to engineer storefronts to provide visibility to a user. Instead, sellers receive actual purchase orders from purchasers and can decide whether or not to accept those orders.

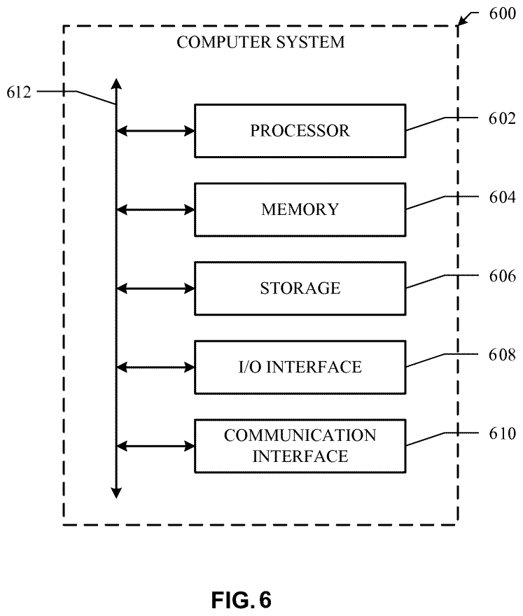

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
receiving, at a computing device and from a client device, a search string for a metal product, the search string having been input by a user of the client device;
determining, by the computing device, a set of one or more search results based on the received search string, each search result based on the search string input by the user, and each search result corresponding to a particular metal product;
transmitting, from the computing device and to the client device, the set of one or more search results for display on the client device;
determining, by the computing device, a price for at least one of the particular metal products, wherein the price is not determined by any particular seller of the metal product; and
transmitting, from the computing device and to the client device, the price for the at least one of the particular metal products for display on the client device.

2. The method of claim 1, further comprising:
accessing a set of a plurality of metal products, each metal product in the set associated with a particular product price; and
determining the presented price based on a combination of each particular product price of each metal product in the set of metal products.

3. The method of claim 2, further comprising determining the presented price based on a combination of each particular product price of each metal product in the set of metal products by averaging each particular product price of each metal production in the set of metal products.

4. The method of claim 3, further comprising adjusting a particular product price based on historical user interactions regarding that particular product when the corresponding product price for that particular product is presented.

5. The method of claim 1, further comprising:
parsing the search string into one or more constituent alphanumeric characters; and
determining, based on the parsed search string, each of the set of search results based on a correspondence between the one or more constituent alphanumeric characters and an identifier for each particular metal product corresponding to the set of search results.

6. The method of claim 1, wherein each search result identifies a product shape of the corresponding metal product, a type of material of the corresponding metal product, a dimensional size of the corresponding metal product, a length of the corresponding metal product, a grade of the corresponding metal product, and a weight of the corresponding metal product.

7. The method of claim 1, further comprising:
receiving, at the computing device and from the client device, a purchase order for at least one of the metal products; and
transmitting, by the computing device, the purchase order to a plurality of seller computing devices.

8. The method of claim 7, further comprising:
receiving, from a first one of the seller computing devices, a request to fulfill the purchase order; and
transmitting, to the client device, (1) an identification of a seller associated with the first one of the seller computing devices, and (2) an identification of the purchase order as finalized.

9. The method of claim 8, further comprising receiving the request to fulfill the purchase order after a predetermined mandatory waiting period for the purchase order.

10. One or more non-transitory computer readable storage media storing instructions and coupled to one or more processors that are operable to execute the instructions to:
receive, from a client device, a search string for a metal product, the search string having been input by a user of the client device;
determine a set of one or more search results based on the received search string, each search result based on the search string input by the user, and each search result corresponding to a particular metal product;
transmit, to the client device, the set of one or more search results for display on the client device;
determine a price for at least one of the particular metal products, wherein the price is not determined by any particular seller of the metal product; and
transmit from the computing device and to the client device, the price for the at least one of the particular metal products for display on the client device.

11. The media of claim 10, further comprising:
accessing a set of a plurality of metal products, each metal product in the set associated with a particular product price; and
determining the presented price based on a combination of each particular product price of each metal product in the set of metal products.

12. The media of claim 11, further comprising determining the presented price based on a combination of each particular product price of each metal product in the set of metal products by averaging each particular product price of each metal production in the set of metal products.

13. A method comprising:
Presenting, on a display of a client device, a user interface comprising a search bar;
Receiving, at the client device, user input comprising a search string for a metal product;
presenting, on the user interface displayed on the client device, one or more search results, each search result based on the search string input by the user, and each search result corresponding to a particular metal product;
presenting, on the user interface displayed on the client device, a price for at least one of the particular metal products, wherein the price is not determined by any particular seller of the metal product.

14. The method of claim 13, wherein the presented price is determined based on a set of a plurality of metal products, each metal product in the set associated with a particular product price, and the presented price is based on a combination of each particular product price of each metal product in the set of metal products.

15. The method of claim 14, wherein the presented price is based on an average of each particular product price of each metal production in the set of metal products.

16. The method of claim 13, wherein each search result identifies a product shape of the corresponding metal product, a type of material of the corresponding metal product, a dimensional size of the corresponding metal product, a length of the corresponding metal product, a grade of the corresponding metal product, and a weight of the corresponding metal product.

17. The method of claim 13, further comprising:
Transmitting, from the client device, the user input to a server device; and
Receiving, at the client device and from the server device, the one or more search results.

18. The method of claim 13, further comprising:
receiving additional user input comprising an updated search string for a metal product; and
presenting, on the user interface displayed on the client device, one or more updated search result, each updated search result based on the updated search string input by the user.

19. The method of claim 13, further comprising:
receiving, at the client device, user input comprising a request to generate a purchase order for the metal product; and
generating, on the display of the client device, a purchase order interface.

20. The method of claim 19, further comprising:
receiving user input on the displayed purchase order interface;
transmitting, from the client device to a server device, a purchase order for the metal product.
